(19) United States
(12) Patent Application Publication
(10) Pub. No.: US 2024/0037447 A1
(43) Pub. Date: Feb. 1, 2024

(54) Training a Reinforcement Learning Agent to Control an Autonomous System

(71) Applicant: Bayerische Motoren Werke Aktiengesellschaft, Muenchen (DE)

(72) Inventors: Joschka BOEDECKER, Freiburg (DE); Maria HUEGLE, Freiburg (DE); Gabriel KALWEIT, Freiburg (DE); Moritz WERLING, Muenchen (DE)

(21) Appl. No.: 18/020,688

(22) PCT Filed: Jun. 14, 2021
(86) PCT No.: PCT/EP2021/065919

§ 371 Date: Feb. 10, 2023

(30) Foreign Application Priority Data
Aug. 11, 2020 (DE) 10 2020 121 150.3

(51) Int. Cl. G06N 20/00

(52) U.S. Cl. CPC G06N 20/00

(57) ABSTRACT

One aspect of the invention relates to a device for training a reinforcement learning agent to control an autonomous system, wherein the device is designed to detect the environment of the autonomous system, to detect at least one object in the environment of the autonomous system that can be compared to the autonomous system, to detect a behaviour of the at least one object that can be compared to the autonomous system, and to train the reinforcement learning agent in accordance with the detected behaviour of the at least one object that can be compared to the autonomous system.

### BACKGROUND AND SUMMARY OF THE INVENTION

The present subject matter relates to a device and a method for training a reinforcement learning agent to control an autonomous system.

The term “autonomous driving” can be understood for the purposes of this document to mean driving with automated longitudinal or lateral guidance, or autonomous driving with automated longitudinal and lateral guidance. The term “autonomous driving” covers automated driving with any degree of automation. Examples of levels of automation are an assisted, partially automated, highly automated or fully automated driving mode. These levels of automation have been defined by the German Federal Highway Research Institute (BASt) (see the BASt publication “Forschung kompakt [Research digest]”, issue November 2012). During assisted driving, the driver performs the longitudinal or lateral guidance all the time, while the system performs the other function within certain limits. In partially automated driving (PAD), the system takes control of the longitudinal and lateral guidance for a certain period of time and/or in specific situations while the driver has to constantly monitor the system, as in assisted driving. In highly automated driving (HAD), the system takes control of the longitudinal and lateral guidance for a certain period of time without the driver having to constantly monitor the system; however, the driver must be in a position to take control of the vehicle within a certain period of time. In fully automated driving (FAD), the system can automatically handle the driving in all situations for a specific application; for this application a driver is no longer required. The four automation levels listed above according to the BASt definition correspond to SAE levels 1 to 4 of the SAE J3016 standard (SAE—Society of Automotive Engineering). For example, highly automated driving (HAD) according to the BASt complies with level 3 of the SAE J3016 standard. In addition, SAE J3016 also provides SAE level 5 as the highest automation level, which is not included in the BASt definition. SAE level 5 is equivalent to driverless driving, in which the system can automatically handle all situations in the same way as a human driver throughout the entire journey; a driver is generally no longer required.

Reinforcement Learning is a series of machine learning methods in which an agent automatically learns a strategy to maximize rewards received. The agent is not shown in advance which action is best in which situation, but receives a reward, which can also be negative, at certain times. Based on these rewards, it approximates a utility function that describes the value of a particular state or action.

A large number of training data records are required to train the agent. The collection of training data records is very time-consuming, in particular where reinforcement learning is used for automated driving, since a test vehicle configured to collect training data experiences only a very limited number of relevant traffic situations in a given time.

It is the object of the present subject matter to increase the number of training data records available for training the reinforcement learning agent.

The object is achieved by the features of the independent patent claims. Advantageous examples are described in the dependent claims. It is pointed out that additional features of a claim that depends on an independent claim may constitute a separate invention independent of the combination of all the features of the independent claim either without the features of the independent claim or only in combination with a subset of the features of the independent claim, which the present subject matter can be made the subject of an independent claim, a divisional application, or a subsequent application. This also applies to technical teachings described in the description, which may constitute the present subject matter that is independent of the features of the independent claims.

A first aspect of the present subject matter relates to a device for training a reinforcement learning agent to control an autonomous system.

The autonomous system, often also referred to as an autonomous robot, is a technical system that behaves or performs its tasks with a high degree of autonomy, i.e. without external control. In particular, the autonomous system is a technical system that moves autonomously, such as an autonomous aircraft, or land-based or water-borne vehicle.

The device is designed to detect the environment of the autonomous system, in particular by using sensors such as cameras, radar and/or lidar. Sensor data of these sensors can be fused, for example, to generate an environment model of the environment of the autonomous system in order to capture the environment of the autonomous system as a whole.

In addition, the device is designed to recognize at least one object comparable to the autonomous system in the environment of the autonomous system.

The at least one object comparable to the autonomous system is comparable to the autonomous system in particular if it has comparable properties and/or a comparable influence on its environment.

The at least one object comparable to the autonomous system can itself be an autonomous system or also a manual, or non-autonomous system, that is, a system controlled by a human being.

In addition, the device is designed to detect a behavior of the at least one object comparable to the autonomous system, and to train the reinforcement learning agent in accordance with the detected behavior of the at least one object comparable to the autonomous system.

The present subject matter is based on the idea that the reinforcement learning agent does not learn from the behavior of the autonomous system which the reinforcement learning agent itself controls or is designed to control, but from the behavior of the at least one object comparable to the autonomous system. In other words, as well as training data records that originate from the autonomous system itself, training data records from the object in the environment of the autonomous system, which is comparable to the autonomous system, can also be used to train the reinforcement learning agent.

In an advantageous example of the present subject matter, the autonomous system is an automated motor vehicle.

The at least one object comparable to the automated motor vehicle in the environment of the automated motor vehicle has comparable properties and/or a comparable influence on its environment as the automated motor vehicle. The characteristics of the motor vehicle are, for example, the dimensions, the acceleration potential, the speed potential and/or the surrounding communication facilities of the automated motor vehicle. The influence of the automated motor vehicle on its environment can be seen, for example, in the distance that other road users maintain from the automated motor vehicle.

The at least one object comparable to the automated motor vehicle in the environment of the automated motor vehicle is in particular another motor vehicle, for example, another motor vehicle from the same motor vehicle class.

In a further advantageous example of the present subject matter, the device is configured to train the reinforcement learning in accordance with the detected behavior of the at least one object comparable to the autonomous system, and on a reward function for controlling the autonomous system.

The present subject matter is based on the finding that it is not necessary to determine a possible reward function of the at least one object comparable to the autonomous system, but that instead, the reward function for controlling the autonomous system can be used to train the reinforcement learning agent.

The reward function for controlling the autonomous system may involve, if the autonomous system is an automated motor vehicle, for example, maintaining a preset speed of the automated motor vehicle. Alternatively or in addition, the reward function may also comprise comfort aspects, such as a limitation of the maximum acceleration of the automated motor vehicle in the longitudinal and/or transverse direction. In addition, the reward function can also comprise safety aspects, such as maintaining safety distances from other road users.

While it is possible, for example, that the reward function of the automated motor vehicle is aimed at maintaining a speed of 50 km/h and that the actual reward function of another road user, as an object comparable to the automated motor vehicle, is to maintain a different speed, e.g. 70 km/h, it is nevertheless not necessary to determine or approximate this reward function of the other road user.

In a further advantageous example of the present subject matter, the device is configured to detect a state of the at least one object comparable to the autonomous system.

The state of the at least one object is described, for example, by its position, speed and/or direction of motion. If the at least one object is a motor vehicle, the state is also described, alternatively or additionally, by its lane and/or the distance of the at least one object from other possible road users.

In addition, the device is configured to detect an action of the at least one object comparable to the autonomous system, which changes the state of the at least one object comparable to the autonomous system.

For example, the action is a change in the position, the speed, and/or the direction of motion of the object. If the object is a motor vehicle, the action is also, for example, a lane change, or the object merging or turning off.

In addition, the device is configured to detect a resulting state of the at least one object comparable to the autonomous system, which is caused by the action of the at least one object comparable to the autonomous system, and to train the reinforcement learning agent in accordance with the state of the at least one object comparable to the autonomous system, the action of the at least one object comparable to the autonomous system, the resulting state of the at least one object comparable to the autonomous system, and a reward function for controlling the autonomous system.

In a further advantageous example of the present subject matter, the device is configured to transform a representation of the at least one object comparable to the autonomous system in the environment of the autonomous system, in such a way that the transformed representation of the at least one object comparable to the autonomous system corresponds to a possible representation of the autonomous system, and to train the reinforcement learning agent in accordance with the detected behavior of the at least one object comparable to the autonomous system.

This transformation is, for example, a coordinate transformation in which the representation of the at least one object comparable to the autonomous system in a coordinate system is placed at the position of the autonomous system.

In a further advantageous example of the present subject matter, the device is configured to recognize at least two objects comparable to the autonomous system in the environment of the autonomous system, to detect a behavior of each of the at least two objects comparable to the autonomous system, and to train the reinforcement learning agent in accordance with the respective detected behavior of the at least two objects comparable to the autonomous system.

In another advantageous example of the present subject matter the device is configured to train the reinforcement learning agent simultaneously in accordance with the respective detected behavior of the at least two objects comparable to the autonomous system.

In this case, the present subject matter is based on the finding that, if a simultaneous training of the reinforcement learning agent is performed in accordance with the respective detected behavior of the at least two objects comparable to the autonomous system, a potentially time-consuming preprocessing of a representation of the at least two objects comparable to the autonomous system can be omitted.

In a further advantageous example of the present subject matter, the device is configured to fuse a representation of the at least two objects comparable to the autonomous system in the environment of the autonomous system using a permutation-invariant or using a permutation-equivariant mapping into a common representation, and to train the reinforcement learning agent in accordance with the common representation.

A second aspect of the present subject matter relates to a method for training a reinforcement learning agent to control an autonomous system.

One step of the method is the detection of the environment of the autonomous system.

A further step of the method is the recognition of at least one object comparable to the autonomous system in the environment of the autonomous system.

A further step of the method is the detection of a behavior of the at least one object comparable to the autonomous system.

A further step of the method is the training of the reinforcement learning agent in accordance with the detected behavior of the at least one object comparable to the autonomous system.

The above comments on the device according to the present subject matter according to the first aspect of the present subject matter also apply in a corresponding way to the method according to the present subject matter according to the second aspect of the present subject matter. Advantageous examples of the method according to the present subject matter that are not explicitly described in this section or in the claims correspond to the advantageous examples of the device according to the present subject matter described above or described in the claims.

The present subject matter is described in further detail below using an example and with the aid of the attached drawings. In the drawings:

### BRIEF DESCRIPTION OF THE DRAWINGS

FIG. 1 shows a driving situation for illustrating the present subject matter,

FIG. 2 shows a schematic example of the present subject matter, and

FIG. 3 shows a further schematic example of the present subject matter.

### DETAILED DESCRIPTION

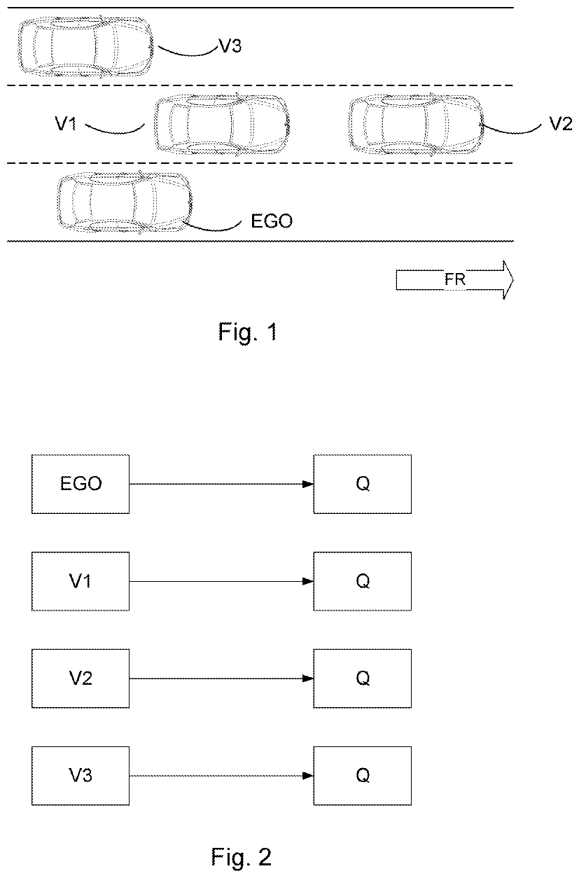

FIG. 1 shows an autonomous system EGO in the form of a motor vehicle, equipped with a device for training a reinforcement learning agent to control an autonomous system EGO.

The device is configured to detect the environment of the autonomous system EGO and to recognize at least one object V1, V2, V3 comparable to the autonomous system EGO in the environment of the autonomous system EGO.

The at least one object V1, V2, V3 comparable to the autonomous system EGO can be, in particular, other road users, for example, other motor vehicles in the environment of the autonomous system EGO.

In addition, the device is designed to detect a behavior of the at least one object V1, V2, V3 comparable to the autonomous system EGO, and to train the reinforcement learning agent in accordance with the detected behavior of the at least one object V1, V2, V3 comparable to the autonomous system EGO.

In this example, the motor vehicle V1 can overtake the motor vehicle V2 only by paying attention to the motor vehicle V3. This non-trivial overtaking operation can be detected by the device in the motor vehicle EGO as the behavior of the motor vehicle V1 and used to train the reinforcement learning agent.

The device is configured, in particular, to train the reinforcement learning in accordance with the detected behavior of the at least one object V1, V2, V3 comparable to the autonomous system EGO, and on a reward function for controlling the autonomous system EGO.

The behavior of the at least one object V1, V2, V3 comparable to the autonomous system EGO is defined, for example, by a state of the at least one object V1, V2, V3 comparable to the autonomous system EGO, by an action of the at least one object V1, V2, V3 comparable to the autonomous system EGO, which changes the state of the at least one object V1, V2, V3 comparable to the autonomous system EGO and/or by a resulting state of the at least one object V1, V2, V3 comparable to the autonomous system EGO, which is caused by the action of the at least one object V1, V2, V3 comparable to the autonomous system EGO.

FIG. 2 shows a schematic example of the present subject matter.

The device shown in the figure is configured to detect at least two objects V1, V2, V3 comparable to the autonomous system EGO in the environment of the autonomous system EGO, to detect a behavior of each of the at least two objects V1, V2, V3 comparable to the autonomous system EGO, and to train the reinforcement learning agent in accordance with the respective detected behavior of the at least two objects V1, V2, V3 comparable to the autonomous system EGO.

The device is configured to train the reinforcement learning agent simultaneously in accordance with the respective detected behavior of the at least two objects V1, V2, V3 comparable to the autonomous system EGO.

For this purpose, the device is configured, for example, to transform a representation of the at least one object V1, V2, V3 comparable to the autonomous system EGO in the environment of the autonomous system EGO, in such a way that the transformed representation of the at least one object V1, V2, V3 comparable to the autonomous system EGO corresponds to a possible representation of the autonomous system EGO, and to train the reinforcement learning agent in accordance with the detected behavior of the at least one object V1, V2, V3 comparable to the autonomous system EGO.

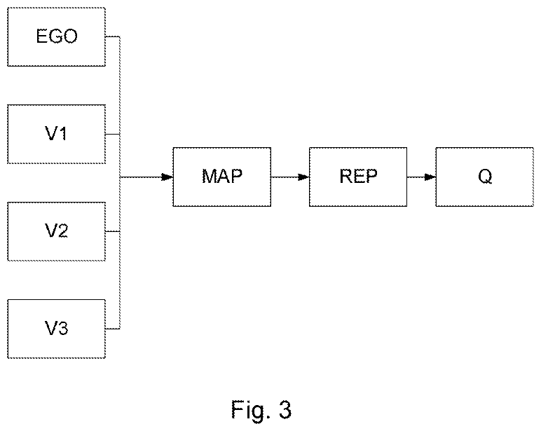

FIG. 3 shows a further schematic example of the present subject matter.

The device shown in the figure is configured to detect at least two objects V1, V2, V3 comparable to the autonomous system EGO in the environment of the autonomous system EGO, to detect a behavior of each of the at least two objects V1, V2, V3 comparable to the autonomous system EGO, and to train the reinforcement learning agent in accordance with the respective detected behavior of the at least two objects V1, V2, V3 comparable to the autonomous system EGO.

In addition, the device is configured to fuse a representation of each of the at least two objects V1, V2, V3 comparable to the autonomous system EGO in the environment of the autonomous system EGO using a permutation-invariant or using a permutation-equivariant mapping MAP into a common representation REP, and to train the reinforcement learning agent in accordance with the common representation REP.

1.-9. (canceled)

10. A device for training a reinforcement learning agent to control an autonomous system, wherein the device is configured to:
detect an environment of the autonomous system;
recognize at least one object comparable to the autonomous system in the environment of the autonomous system;
detect a behavior of the at least one object comparable to the autonomous system; and
train the reinforcement learning agent in accordance with the detected behavior of the at least one object comparable to the autonomous system.

11. The device according to claim 10, wherein
the autonomous system is an automated motor vehicle.

12. The device according to claim 10, wherein the device is further configured to:
train the reinforcement learning in accordance with:
the detected behavior of the at least one object comparable to the autonomous system; and
a reward function for controlling the autonomous system.

13. The device according to claim 10, wherein the device is further configured to:
detect a state of the at least one object comparable to the autonomous system;
detect an action of the at least one object comparable to the autonomous system, which changes the state of the at least one object comparable to the autonomous system;
detect a resulting state of the at least one object comparable to the autonomous system, which is caused by the action of the at least one object comparable to the autonomous system; and
train the reinforcement learning agent in accordance with:
the state of the at least one object comparable to the autonomous system,
the action of the at least one object comparable to the autonomous system,
the resulting state of the at least one object comparable to the autonomous system, and
a reward function for controlling the autonomous system.

14. The device according to claim 10, wherein the device is further configured to:
transform a representation of the at least one object comparable to the autonomous system in the environment of the autonomous system such that the transformed representation of the at least one object comparable to the autonomous system corresponds to a possible representation of the autonomous system; and
train the reinforcement learning agent in accordance with the detected behavior of the at least one object comparable to the autonomous system.

15. The device according to claim 10, wherein the device is further configured to:
recognize at least two objects comparable to the autonomous system in the environment of the autonomous system;
detect the behavior of each of the at least two objects comparable to the autonomous system; and
train the reinforcement learning agent in accordance with the respective detected behavior of the at least two objects comparable to the autonomous system.

16. The device according to claim 14, wherein the device is further configured to:
train the reinforcement learning agent simultaneously in accordance with the respective detected behavior of the at least two objects comparable to the autonomous system.

17. The device according to claim 14, wherein the device is further configured to:
fuse a representation of the at least two objects comparable to the autonomous system in the environment of the autonomous system using a permutation-invariant or using a permutation-equivariant mapping into a common representation; and
train the reinforcement learning agent in accordance with the common representation.

18. A method for training a reinforcement learning agent to control an autonomous system, comprising:
detecting an environment of the autonomous system;
recognizing at least one object comparable to the autonomous system in the environment of the autonomous system;
detecting a behavior of the at least one object comparable to the autonomous system; and
training the reinforcement learning agent in accordance with the detected behavior of the at least one object comparable to the autonomous system.
